(19) United States
(12) Patent Application Publication
(10) Pub. No.: US 2010/0190881 A1
(43) Pub. Date: Jul. 29, 2010

(54) Radiation Curable Compositions Useful in Solid Freeform Fabrication Systems

(75) Inventor: Bettina Steinmann, Praroman (CH)

Correspondence Address: 3D Systems, Inc.;Attn: Keith A. Roberson, 333 Three D Systems Circle, Rock Hill, SC, 29730, US

(73) Assignee: 3D Systems, Incorporated

(21) Appl. No.: 12/360,865

(22) Filed: Jan. 28, 2009

(51) Int. Cl. C08F 291/10; C08F 299/04; C08F 4/42

(52) U.S. Cl. 522/8; 522/104; 522/27

(57) ABSTRACT

There are provided liquid radiation-curable compositions useful for the production of three-dimensional solid articles in solid freeform fabrication systems. The compositions include a cationically polymerizing alicyclic epoxide having at least two epoxy groups, at least one cationic photoinitiator; at least one free radical photoinitiator; and at least one dendritic polymer having either at least six hydroxyl functional groups or at least six (meth)acrylate functional groups.

### FIELD OF THE INVENTION

The present invention relates to radiation curable compositions useful as solid freeform fabrication resins. More preferably, the present invention relates to certain epoxy and (meth)acrylate-based compositions that contain at least one dendritic polymer having at least six hydroxyl-functional groups or at least six (meth)acrylate groups.

### BACKGROUND OF THE INVENTION

Radiation-curable solid freeform fabrication resin formulations containing various combinations of epoxy compounds and (meth)acrylate compounds along with other compounds are well known. Such resin formulations are cured in commercial solid freeform fabrication systems, such as stereolithography systems to name one non-limiting example, to form three-dimensional solid images. This usage is commonly referred to as rapid prototyping or rapid manufacturing. The radiation source for forming these solid images from the curable resin has typically been laser scanning, although alterative radiation sources such as light image projection systems have been considered.

The curable resins used in such solid freeform fabrication systems need to have a combination of desirable properties. Preferably, such resins should have little or no surface tackiness after curing, yet have sufficient physical properties so that they form useful three-dimensional objects. In particular, a combination of high temperature resistance and good mechanical properties is especially desired. While existing epoxy/(meth)acrylate resins are suitable for use in making three dimensional articles with solid freeform fabrication systems, there is still a need for better resins that cure faster and more thoroughly while also having a combination of very good mechanical properties such as high green strength, low humidity sensitivity, high temperature resistance, improved impact resistance along with high flexure modulus and tensile modulus.

### BRIEF SUMMARY OF THE INVENTION

One aspect of the present invention is directed to a liquid radiation-curable composition useful for the production of three-dimensional solid articles in solid freeform fabrication systems, the composition comprising:

(A) at least one cationically polymerizing alicyclic epoxide having at least two epoxy groups;

(B) at least one poly(meth)acrylate compound;

(C) at least one cationic photoinitiator;

(D) at least one free radical photoinitiator; and

(E) at least one dendritic polymer having at least six hydroxyl functional groups.

Still another aspect of the present invention is directed to three-dimensional solid articles made from the above-noted curable composition by a solid freeform fabrication system.

Another aspect of the present invention is directed to a liquid radiation-curable composition useful for the production of three-dimensional solid articles in solid freeform fabrication systems, the composition comprising:

(A) at least one cationically polymerizing alicyclic epoxide having at least two epoxy groups;

(B) at least one dendritic polymer having at least six (meth)acrylate functional groups;

(C) at least one cationic photoinitiator; and

(D) at least one free radical photoinitiator.

Still another aspect of the present invention is directed to three-dimensional solid articles made from the above-noted curable composition by a solid freeform fabrication system.

The compositions of the present invention have the advantage of having the above-noted combination of desirable curing and mechanical properties. In particular, it has been found that solid freeform fabrication resins containing dendritic polymers with hydroxyl terminal functionalities have very high temperature resistance. Also, it has been found that solid freeform fabrication resins containing dendritic polymers with (meth)acrylate terminal functionalities show very high impact resistance.

### DETAILED DESCRIPTION OF THE INVENTION

The term “(meth)acrylate” as used in the present specification and claims refers to both acrylates and methacrylates.

The term “poly(meth)acrylate” as used in the present specification refers to both acrylates and methacrylates that have more than one acrylate or methacrylate functionality. Examples include diacrylates, triacrylates, tetraacrylates, pentaacrylates, dimethacrylates, trimethacrylates, tetramethacrylates and pentamethacrylates.

It is to be understood that the terms “light” and “radiation” as used in the present specification can mean electromagnetic radiation in the wavelength range including infrared, visible, ultraviolet and x rays, that when traveling in a vacuum moves with a speed of about 186,281 miles per second or 300,000 kilometers per second.

The term “liquid” as used in the present specification and claims is to be equated with “liquid at room temperature” which is, in general, a temperature between 5° C. and 30° C.

The novel compositions of the present invention contain a mixture of several separate components or compounds listed herein. The compositions may contain these separate ingredients in any proportion that would be useful as radiation-curable compositions in solid freeform fabrication systems. These compositions may further optionally contain many optional ingredients such as reactive diluents, polyols, colorants and other additives.

### Alicyclic Epoxides Having at Least Two Epoxy Groups

The cationically polymerizing alicyclic epoxides having at least two epoxy groups include any cationically curable liquid or solid compound that may be an alicyclic polyglycidyl compound or cycloaliphatic polyepoxide which on average possesses two or more epoxide groups (oxirane rings) in the molecule. Such resins may have a cycloaliphatic ring structure that contains the epoxide groups as side groups or the epoxide groups from part of the alicyclic ring structure. Such resins of these types are known in general terms and are commercially available.

Examples of compounds in which the epoxide groups form part of an alicyclic ring system include bis(2,3-epoxycyclopentyl) ether; 2,3-epoxycyclopentyl glycidyl ether, 1,2-bis(2,3-epoxycyclopentyloxy)ethane; bis(4-hydroxycyclohexyl) methane diglycidyl ether, 2,2-bis(4-hydroxycyclohexyl) propane diglycidyl ether; 3,4-epoxycyclohexylmethyl-3′,4′-epoxycyclohexanecarboxylate; 3,4-epoxy-6-methyl-cyclohexylmethyl 3,4-epoxy-6-methylcyclohexanecarboxylate; di(3,4-epoxycyclohexylmethyl) hexanedioate; di(3,4-epoxy-6-methylcyclohexylmethyl) hexanedioate; ethylenebis(3,4-epoxycyclohexane-carboxylate, ethanediol di(3,4-epoxycyclohexylmethyl) ether; vinylcyclohexane dioxide; dicyclopentadiene diepoxide or 2-(3,4-epoxycyclohexyl-5,5-spiro-3,4-epoxy)cyclohexane-1,3-dioxane.

The preferred alicyclic epoxide is 3,4-epoxy cyclohexylmethyl-3′,4′-epoxy cyclohexanecarboxylate which is available as Cyracure UVR 6110 or as UVACURE 1500.

These alicyclic epoxides preferably constitute from about 40% to about 70% by weight, more preferably from about 45% to 65% by weight, of the total cationic polymerizing organic substances.

### Poly(meth)acrylate Compounds

The compositions of the present invention may also preferably contain at least one poly(meth)acrylate compound. This component is different than the other components in this composition and does not include the (meth)acrylate functional dendritic polymers discussed below. This component may be a di(meth)acrylate monomer that may be polymerized by free radicals. For example, this component may be tricyclodecane dimethanol diacrylate monomer such as Sartomer SR833S available from Sartomer Company. This compound can be used in a variety of applications wherein both flexibility and toughness are required.

The compositions of the present invention may also preferably contain at least one aromatic di(meth)acrylate compounds include difunctional aromatic acrylates or difunctional aromatic methacrylates. Suitable examples of these di(meth)acrylate compounds include di(meth)acrylates of aromatic diols such as hydroquinone, 4,4′-dihydroxybis-phenyl, bisphenol A, bisphenol F, bisphenol S, ethoxylated or propoxylated bisphenol A, ethoxylated or propoxylated bisphenol F or ethoxylated or propoxylated bisphenol S. Di(meth)acrylates of this kind are known and some are commercially available.

The most preferred aromatic difunctional (meth)acrylate is bisphenol A diglycidylether diacrylate which is available as Ebecryl 3700.

These aromatic difunctional (meth)acrylates preferably constitute from about 10% to about 20% by weight, or more preferably from about 12% to about 18% by weight, of the total liquid radiation-curable composition.

The compositions of the present invention may also preferably contain at least one trifunctional or higher functional (meth)acrylates. These are preferably tri-, tetra- or penta-functional monomeric or oligomeric aliphatic, cycloaliphatic or aromatic acrylates or methacrylates. Such compounds preferably have a molecular weight of from about 200 to about 500.

Examples of suitable aliphatic tri-, tetra- and penta-functional (meth)acrylates are the triacrylates and trimethacrylates of hexane-2,4,6-triol; glycerol or 1,1,1-trimethylolpropane; ethoxylated or propoxylated glycerol; or 1,1,1-trimethylolpropane; and the hydroxyl-containing tri(meth)acrylates which are obtained by reacting triepoxide compounds, for example the triglycidyl ethers of said triols, with (meth)acrylic acid. It is also possible to use, for example, pentaerythritol tetraacrylate, bistrimethylolpropane tetraacrylate, pentaerythritol monohydroxytriacrylate or -methacrylate, or dipentaerythritol monohydroxypentaacrylate or -methacrylate.

Examples of suitable aromatic (tri)methacrylates are the reaction products of triglycidyl ethers of trihydric phenols and phenol or cresol novolaks containing three hydroxyl groups, with (meth)acrylic acid.

The poly(meth)acrylates employed as this component are known compounds and some are commercially available, for example from the SARTOMER Company under product designations such as SR295, SR350, SR351, SR367, SR399, SR444, SR454 or SR9041.

A preferred higher functional (meth)acrylate compound is SARTOMER SR399, which is a dipentaerythritol monohydroxy-pentaacrylate.

These higher functional (meth)acrylates, if used, preferably constitute about 1% to about 10% by weight, or more preferably from about 1.5% to about 9% by weight, of the total liquid radiation-curable composition.

The total poly(meth)acrylate compound or compounds preferably constitute from about 15% to about 35% by weight, or more preferably from about 18% to about 25% by weight, of the total composition.

### Dendritic Polymers Having At Least Six Hydroxyl Functional Groups

Dendritic polymers are characterized by a densely branched backbone and a large number of reacting groups. From a structural standpoint, dendritic polymers are quite different from typical oligomers used in radiation cure applications. They have a “globular” morphology rather than the typical linear morphology. They are also known as hyperbranched compounds. In the case of the hydroxyl-functional dendritic polymers used in some compositions of the present invention, they must have at least six hydroxyl groups. Preferred hydroxyl-functional dendritic polymers include Boltorn H2003 (having twelve terminal hydroxyl groups) and Boltorn H2004 (having six terminal hydroxyl groups) which are polyesters commercially available from Perstorp Group (www.Perstorp.com). Of course any hydroxyl-functional dendritic polymer that produces useful solid freeform fabrication resins may be may herein.

The total hydroxyl-functional dendritic polymer compound or compounds preferably constitute from about 1% to about 7% by weight, or more preferably from about 1.5% to about 4% by weight, of the total composition.

### Dendritic Polymers Having At Least Six (Meth)acrylate Groups

A component of some compositions of present invention is at least one dendritic polymer having at least six (meth)acrylate terminal groups. See the Sartomer publication dated March 2008 by J. A. Klang entitled “Radiation Curable Hyperbranched Polyester Acrylates” for a detailed discussion of these compounds, the disclosure thereof being incorporated by reference in its entirety herein. For the present invention, one preferred example of this first component is SARTOMER CN2881 hyperbranched polyester poly(meth)acrylate available from the Sartomer Company. Other hyperbranched polyester acrylate compounds that may be suitable for the present invention include CN2300, CN2301, CN2303, and CN2304, all available from Sartomer and discussed in the Klang article. Of course, other hyperbranched polyester poly(meth)acrylate compounds and mixtures of hyperbranched compounds may be used if they are able to produce useful three-dimensional articles. In certain preferred embodiments of the present invention, the hyperbranched polyester or dendritic polymer compound having at least six (meth)acrylate groups constitutes about 10% to about 25% by weight of the total composition.

### Cationic Polymerization Initiators (Photoinitiators)

In the compositions according to the invention, any type of cationic polymerization initiators (also called photoinitiators) that, upon exposure to actinic radiation, forms cations that initiate the reactions of the epoxy material(s) can be used. There are a large number of known and technically proven cationic photoinitiators for epoxy resins that are suitable. They include, for example, onium salts with anions of weak nucleophilicity. Examples are halonium salts, iodosyl salts or sulfonium salts, such as described in published European patent application EP 153904, sulfoxonium salts, such as described, for example, in published European patent applications EP 35969, 44274, 54509, and 164314, or diazonium salts, such as described, for example, in U.S. Pat. Nos. 3,708,296 and 5,002,856. Other cationic photoinitiators are metallocene salts, such as described, for example, in published European applications EP 94914 and 94915. Other preferred cationic photoinitiators are mentioned in U.S. Pat. Nos. 5,972,563; 6,100,007; and 6,136,497.

More preferred commercial cationic photoinitiators are UVI-6974, UVI-6970, UVI-6990 (manufactured by Dow Chemical), CD-1010, CD-1011, CD-1012 (manufactured by Sartomer Corp.), Adekaoptomer SP-150, SP-151, SP-170, SP-171 (manufactured by Asahi Denka Kogyo Co., Ltd.), Irgacure 261 (Ciba Specialty Chemicals Corp.), CI-2481, CI-2624, CI-2639, CI-2064 (Nippon Soda Co., Ltd.), DTS-102, DTS-103, NAT-103, NDS-103, TPS-103, MDS-103, MPI-103, BBI-103 (Midori Chemical Co., Ltd.). Most preferred are UVI-6974, CD-1010, UVI-6970, Adekaoptomer SP-170, SP-171, CD-1012, and MPI-103. The above mentioned cationic photoinitiators can be used either individually or in combination of two or more.

The most preferred cationic photoinitiator is a triarylsulfonium hexafluoroantimonate such as UVI-6976 (from Dow Chemical).

The cationic photoinitiators may constitute from about 1% to about 7% by weight, more preferably, from about 2% to about 5% by weight, of the total radiation-curable composition.

### Free Radical Polymerization Initiators (Photoinitators)

Another component of the compositions of the present invention is at least one free radical polymerization initiator (also called photoinitiators). While more than one photoinitator may be used in this invention, it is preferred to use at least one UV light range photoinitiator, especially when UV light radiation source such a UV light scanning laser system is used to produce the three-dimensional object. In certain preferred embodiments of the present invention, the total amount of photoinitiators is about 0.1% to about 5% by weight of the total resin composition.

The UV light range free radical polymerization initiator(s) can be any free radical polymerization initiator(s) that will start a free radical reaction when exposed to radiation in the UV light spectrum (including about 260 nanometers to about 380 nanometers). The preferred UV light range free radical polymerization initiator(s) is 1-hydroxycyclohexyl phenyl ketone that is available as IRGACURE I-184 from Ciba Specialty Chemicals, Inc.

### Other Optional Additives

If necessary, the resin composition for image applications according to the present invention may contain other materials in suitable amounts, as far as the effect of the present invention is not adversely affected. Examples of such materials include coloring agents such as sensitizers, stabilizers, pigments and dyes, reactive diluents, fillers, antifoaming agents, leveling agents, thickening agents, flame retardants and antioxidants.

Two preferred optional additives are pyrene and benzyl dimethyl amine. The former acts as a sensitizer and the latter acts as a cationic stabilizer. If used, optional additives such as these preferably constitute from about 0.001% to about 5% by weight of the total liquid radiation-curable compositions.

Another class of optional additives is reactive diluents such as glycidyl ethers or glycidyl esters or oxetanes or the like. Such cationically polymerizing difunctional or higher functional glycidyl ethers of a polyhydric compound are obtainable by reacting a compound having at least two free alcoholic hydroxyl groups with a suitably substituted epichiorohydrin under alkaline conditions or in the presence of an acidic catalyst followed by alkali treatment. Ethers of this type may be derived from acyclic alcohols, such as ethylene glycol; propane-1,2-diol or poly (oxy propylene) glycols; propane-1,3-diol; butane-1,4-diol; poly (oxytetramethylene) glycols; pentane-1,5-diols; hexane-1,6-diol; hexane-2,4,6-triol; glycerol; 1,1,1-trimethylol propane; bistrimethylol propane; pentacrytliritol; 2,4,6-triol sorbitol and the like when reacted with polyepichlorohydrins. Such resins of these types are known in general terms and are commercially available.

One preferred difunctional or higher functional glycidyl ether is trimethylol propane triglycidyl ether which is available as Araldite DY-T. Another is a bisphenol A diglycidyl ether which is available as Epilox A18-00. Still another is poly tetrahydrofuran diglycidyl ether available as Grilonit F713.

These difunctional or higher functional glycidyl ether preferably constitute from about 10% to about 50% by weight, more preferably about 15% to about 40% by weight of the total liquid radiation composition.

Another class of optional additives is aliphatic hydroxyl-functional compounds. These include any aliphatic-type compounds that contain one or more reactive hydroxyl groups. Preferably these aliphatic hydroxyl functional compounds are multifunctional compounds (preferably with two to five hydroxyl functional groups) such as multifunctional alcohols, polyether-alcohols and polyesters.

Preferably the organic material contains two or more primary or secondary aliphatic hydroxyl groups. The hydroxyl group may be internal in the molecule or terminal. Monomers, oligomers or polymers can be used. The hydroxyl equivalent weight, i.e., the number average molecular weight divided by the number of hydroxyl groups, is preferably in the range of about 31 to 5000.

Representative examples of suitable organic materials having a hydroxyl functionality of 1 include alkanols, monoalkyl ethers of polyoxyalkyleneglycols, monoalkyl ethers of alkylene-glycols, and others.

Representative examples of useful monomeric polyhydroxy organic materials include alkylene glycols and polyols, such as 1,2,4-butanetriol, 1,2,6-hexanetriol; 1,2,3-heptanetriol; 2,6-dimethyl-1 2,6-hexanetriol; 1,2,3-hexanetriol; 1,2,3-butanetriol; 3-methyl-1,3,5-pentanetriol; 3,7,11,15-tetramethyl-1,2,3-hexadecanetriol; 2,2,4,4-tetramethyl-1,3-cyclobutanediol; 1,3-cyclopentanediol; trans-1,2-cyclooctanediol; 1,16-hexadecanediol; 1,3-propanediol; 1,4-butanediol; 1,5-pentanediol; 1,6-hexanediol; 1,7-heptanediol; 1,8-octanediol; and 1,9-nonanediol.

Representative examples of useful oligomeric and polymeric hydroxyl-containing materials include polyoxyethylene and polyoxypropylene glycols and triols of molecular weights from about 2-00 to about 10,000; polytetramethylene glycols of varying molecular weight; copolymers containing pendant hydroxyl groups formed by hydrolysis or partial hydrolysis of vinyl acetate copolymers, polyvinylacetal resins containing pendant hydroxyl groups; hydroxyl-terminated polyesters and hydroxyl-terminated polylactones; hydroxyl-functionalized and polyalkadienes, such as polybutadiene; and hydroxyl-terminated polyethers.

Other hydroxyl-containing monomers are 1,4-cyclohexanedimethanol and aliphatic and cycloaliphatic monohydroxy alkanols. Other hydroxyl-containing oligomers and polymers include hydroxyl and hydroxyl/epoxy functionalized polybutadiene, polycaprolactone diols and triols, ethylene/butylenes polyols, and combinations thereof. Examples of polyether polyols are also polypropylene glycols of various molecular weights and glycerol propoxylate-β-ethoxylate triol, as well as linear and branched polytetrahydrofuran polyether polyols available in various molecular weights, such as for example 250, 650, 1000, 2000, and 2900.

Preferred hydroxyl functional compounds are, for instance, simple multifunctional alcohols, polyether-alcohols, and/or polyesters. Suitable examples of multifunctional alcohols are trimethylolpropane, trimethylolethane, pentaeritritol, di-pentaeritritol, glycerol, 1,4-hexanediol, 1,4-hexanedimethanol and the like.

Suitable hydroxyfunctional polyether alcohols are, for example, alkoxylated trimethylolpropane, in particular the ethoxylated or propoxylated compounds, polyethyleneglycol-200 or -600 and the like.

Suitable polyesters include hydroxyfunctional polyesters from diacids and diols with optionally small amounts of higher functional acids or alcohols. Suitable diols are those described above. Suitable diacids are, for example, adipic acid, dimer acid, hexahydrophthalic acid, 1,4-cyclohexane dicarboxylic acid and the like. Other suitable ester compounds include caprolactone based oligo- and polyesters such as the trimethylolpropane-triester with caprolactone, Tone.RTM.301 and Tone.RTM.310 (Union Carbide Chemical and Plastics Co., or UCCPC). The ester based polyols preferably have a hydroxyl number higher than about 50, in particular higher than about 100. The acid number preferably is lower than about 10, in particular lower than about 5. One preferred aliphatic hydroxyl functional compound is trimethylolpropane, which is commercially available. Another preferred compound is glycerine propoxylated polyether triol having an average molecular weight available as Voranol CP 450.

If used, these optional aliphatic hydroxyl functional compounds are preferably present from about 1% to 20% by weight of the total liquid radiation-curable composition.

Still another class of optional additives are aromatic hydroxyl functional compounds. These include aromatic-type compounds that contain one or more reactive hydroxyl groups. Preferably these aromatic hydroxyl functional compounds would include phenolic compounds having at least two hydroxyl groups as well as phenolic compounds having at least two hydroxyl groups which are reacted with ethylene oxide, propylene oxide or a combination of ethylene oxide and propylene oxide.

The most preferred aromatic functional compounds include bisphenol A, bisphenol S, ethoxylated bisphenol A, and ethoxylated bisphenol S.

If added, these optional aromatic hydroxyl functional compounds are preferably present from about 1% to about 20% by weight, more preferably, from about 5% to about 15% by weight, of the total liquid radiation-cured composition.

For some applications, it is also desirable to use a filler. The optional filler to be used in the present invention is a reactive or non-reactive, inorganic or organic, powdery, fibrous or flaky material. Examples of organic filler materials are polymeric compounds, thermoplastics, core-shell, aramid, Kevlar, nylon, crosslinked polystyrene, crosslinked poly (methyl methacrylate), polystyrene or polypropylene, crosslinked polyethylene powder, crosslinked phenolic resin powder, crosslinked urea resin powder, crosslinked melamine resin powder, crosslinked polyester resin powder and crosslinked epoxy resin powder. Examples of inorganic fillers are glass or silica beads, calcium carbonate, barium sulfate, talc, mica, glass or silica bubbles, zirconium silicate, iron oxides, glass fiber, asbestos, diatomaceous earth, dolomite, powdered metals, titanium oxides, pulp powder, kaolin, modified kaolin, hydrated kaolin metallic filers, ceramics and composites. Mixtures of organic and/or inorganic fillers can be used.

Further examples of preferred fillers are microcrystalline silica, crystalline silica, amorphous silica, alkali alumino silicate, feldspar, woolastonite, alumina, aluminum hydroxide, glass powder, alumina trihydrate, surface treated alumina trihydrate, and alumina silicate. Each of the preferred fillers is commercially available. The most preferred filler materials are inorganic fillers, such as imsil, Novasite, mica, amorphous silica, feldspar, and alumina trihydrate. Mica as a filler is very attractive because it shows low tendency to settle out from the photocurable compositions. It has transparency to UV light, low tendency to refract or reflect incident light and it provides good dimensional stability and heat resistance.

The filler to he used for the resin composition for solid freeform fabrication according to the present invention must satisfy requirements that it hinders neither cationic nor radical polymerizations and the filled solid freeform fabrication composition has a relatively low viscosity suitable for the stereolithography process and other solid freeform fabrication processes. These fillers may be used alone or as a mixture of two or more of them depending upon the desired performance. The fillers used in the present invention may be neutral acidic or basic. The filler particle size may vary depending on the application and the desired resin characteristics. It may vary between 20 nanometers and 50 micrometers.

The filler material can optionally be surface treated with various compounds-coupling agents. Examples include methacryloxy propyl trimethoxy silane, beta-(3,4-epoxycyclohexyl) ethyl trimethoxy silane, gamma-glycidoxy propyl trimethoxy silane and methyl triethoxy silane. The most preferred coupling agents are commercially available from Osi Chemicals Corp. and other chemical suppliers.

The filler loading is preferably from about 0.5% to about 90%, more preferably from about 5% to about 75%, most preferably from about 5% to about 60% by weight with respect to the total weight of the filled resin composition.

### Formulation Preparation

The novel compositions can be prepared in a known manner by, for example, premixing individual components and then mixing these premixes, or by mixing all of the components using customary devices, such as stirred vessels, in the absence of light, if desired, at slightly elevated temperature.

### Process for Making Cured Three-Dimensional Articles

The novel compositions can be polymerized by irradiation with actinic light, for example by means of electron beams, X-rays, UV or visible light, preferably with radiation in the wavelength range of 280 nm to 650 nm. Particularly suitable are laser beams of HeCd, argon or nitrogen and also metal vapor and NdYAG lasers. This invention is extended throughout the various types of lasers existing or under development that are to be used for the stereolithography process, e.g., solid state, argon ion, helium cadmium lasers, and the like, as well other actinic radiation sources used in other solid freeform fabrication processes. The person skilled in the art is aware that it is necessary, for each chosen light source, to select the appropriate photoinitiator and, if appropriate, to carry out sensitization. It has been recognized that the depth of penetration of the radiation into the composition to be polymerized, and also the operating rate, are directly proportional to the absorption coefficient and to the concentration of the photoinitiator. In solid freeform fabrication it is preferred to employ those photoinitiators which give rise to the highest number of forming free radicals or cationic particles and which enable the greatest depth of penetration of the radiation into the compositions which are to be polymerized.

The invention additionally relates to a method of producing a cured product, in which compositions as described above are treated with actinic radiation. For example, it is possible in this context to use the novel compositions as adhesives, as coating compositions, as photo resists, for example as solder resists, or for solid freeform fabrication, but especially for stereolithography. When the novel mixtures are employed as coating compositions, the resulting coatings on wood, paper, metal, ceramic or other surfaces are clear and hard. The coating thickness may vary greatly and can for instance be from about 0.01 mm to about 1 mm. Using the novel mixtures it is possible to produce relief images for printed circuits or printing plates directly by irradiation of the mixtures, for example by means of a computer-controlled laser beam of appropriate wavelength or employing a photomask and an appropriate light source.

One specific embodiment of the above mentioned method is a process for the solid freeform fabrication of a three-dimensional shaped article, in which the article is built up from a novel composition with the aid of a repeating, alternating sequence of steps (a) and (b); in step (a), a layer of the composition, one boundary of which is the surface of the composition, is cured with the aid of appropriate radiation within a surface region which corresponds to the desired cross-sectional area of the three-dimensional article to be formed, at the height of this layer, and in step (b) the freshly cured layer is covered with a new layer of the liquid, radiation-curable composition, this sequence of steps (a) and (b) being repeated until an article having the desired shape is formed. In this process, the radiation source used is preferably a laser beam, which with particular preference is computer-controlled.

In general, the above-described initial radiation curing, in the course of which the so-called green models are obtained which do not as yet exhibit adequate strength, is followed then by the final curing of the shaped articles by heating and/or further irradiation.

The present invention is further described in detail by means of the following Examples. All parts and percentages are by weight and all temperatures are degrees Celsius unless explicitly stated otherwise.

### EXAMPLES 1 to 8

The trade names of the components as indicated in the Examples 1 to 8 are shown in Table 1 as follows:

TABLE 1
List of material identities and chemical compositions.

| TRADE NAMES | CHEMICAL DESIGNATION |
|---|---|
| UVR 6110 | 3,4-epoxy cyclohexylmethyl-3′,4′- |
| | epoxy cyclohexanecarboxylate |
| Araldite DY-T | Trimethylolpropane triglycidyl ether |
| Trimethylolpropane | Trimethylolpropane |
| Sartomer SR399 | Dipentaerythritol pentaacrylate |
| Ebecryl 3700 | Bisphenol A diglycidyl ether |
| | diacrylate |
| UVI 6976 | Triarylsulfonium |
| | hexafluoroantimonate |
| I-184 | 1-Hydrocyclohexyl phenyl ketone |
| Pyrene | Pyrene |
| Boltorn H2003 | Dendritic polymer with 12 terminal |
| | hydroxyl groups per molecule |
| Boltorn H2004 | Dendritic polymer with six terminal |
| | hydroxyl groups per molecule |

The formulations indicated in the Examples below were prepared by mixing the components with a stirrer at 60° C. until a homogeneous composition was obtained. The physical data relating to these formulations was obtained as follows: the viscosity of each formulation was determined at 30° C. using a Brookfield viscometer; the measured post-cure mechanical properties of the formulations were determined on three-dimensional specimens produced stereolithographically with the aid of a Nd-Yag-laser.; the Glass Transition temperatures of each formulation were determined by the “DMA” method; the Tensile Modulus (MPa), Tensile Strength (MPa), Elongation at Break (%), were all determined according to the ISO 527 method; and the Impact Resistance (notched, kj/m²) was determined according to the ISO 179 method.

### EXAMPLE 1

The following components were mixed to produce the homogeneous liquid composition of Example 1:

TABLE 2
List of components and percentage by weight for Example 1.

| COMPONENT | PERCENTAGE (by wt.) |
|---|---|
| UVR 6110 | 47.6 |
| Araldite DY-T | 20 |
| Trimethylolpropane | 4 |
| Sartomer SR399 | 8 |
| Ebecryl 3700 | 15 |
| UVI 6976 | 2.5 |
| 184 | 1 |
| Pyrene | 0.4 |
| Boltorn H2003 | 1.5 |
| Boltorn H2004 | 0 |
| Total | 100 |

### EXAMPLE 2

The following components were mixed to produce the homogeneous liquid composition of Example 2:

TABLE 3
List of components and percentage by weight for Example 2.

| COMPONENT | PERCENTAGE (by wt.) |
|---|---|
| UVR 6110 | 50.6 |
| Araldite DY-T | 20 |
| Trimethylolpropane | 4 |
| Sartomer SR399 | 15 |
| Ebecryl 3700 | 15 |
| UVI 6976 | 2.5 |
| I-184 | 1 |
| Pyrene | 0.4 |
| Boltorn H2003 | 1.5 |
| Boltorn H2004 | 0 |
| Total | 100.00 |

### EXAMPLE 3

The following components were mixed to produce the homogeneous liquid composition of Example 3:

TABLE 4
List of components and percentage by weight for Example 3.

| COMPONENT | PERCENTAGE (by wt.) |
|---|---|
| UVR 6110 | 50.6 |
| Araldite DY-T | 20 |
| Trimethylolpropane | 4 |
| Sartomer SR399 | 5 |
| Ebecryl 3700 | 15 |
| UVI 6976 | 2.5 |
| 184 | 1 |
| Pyrene | 0.4 |
| Boltorn H2003 | 0 |
| Boltorn H2004 | 1.5 |
| Total | 100 |

### EXAMPLE 4

The following components were mixed to produce the homogeneous liquid composition of Example 4:

TABLE 5
List of components and percentage by weight for Example 4.

| COMPONENT | PERCENTAGE (by wt.) |
|---|---|
| UVR 6110 | 49.1 |
| Araldite DY-T | 20 |
| Trimethylolpropane | 4 |
| Sartomer SR399 | 5 |
| Ebecryl 3700 | 15 |
| UVI 6976 | 2.5 |
| I-184 | 1 |
| Pyrene | 0.4 |
| Boltorn H2003 | 0 |
| Boltorn H2004 | 3 |
| Total | 100.00 |

### EXAMPLE 5

The following components were mixed to produce the homogeneous liquid composition of Example 5:

TABLE 6
List of components and percentage by weight for Example 5.

| COMPONENT | PERCENTAGE (by wt.) |
|---|---|
| UVR 6110 | 54.1 |
| Araldite DY-T | 15 |
| Trimethylolpropane | 4 |
| Sartomer SR399 | 5 |
| Ebecryl 3700 | 15 |
| UVI 6976 | 2.5 |
| 184 | 1 |
| Pyrene | 0.4 |
| Boltorn H2003 | 0 |
| Boltorn H2004 | 3 |
| Total | 100 |

### EXAMPLE 6

The following components were mixed to produce the homogeneous liquid composition of Example 6:

TABLE 7
List of components and percentage by weight for Example 6.

| COMPONENT | PERCENTAGE (by wt.) |
|---|---|
| UVR 6110 | 56.1 |
| Araldite DY-T | 15 |
| Trimethylolpropane | 2 |
| Sartomer SR399 | 5 |
| Ebecryl 3700 | 15 |
| UVI 6976 | 2.5 |
| I-184 | 1 |
| Pyrene | 0.4 |
| Boltorn H2003 | 0 |
| Boltorn H2004 | 3 |
| Total | 100.00 |

### EXAMPLE 7

The following components were mixed to produce the homogeneous liquid composition of Example 7:

TABLE 8
List of components and percentage by weight for Example 7.

| COMPONENT | PERCENTAGE (by wt.) |
|---|---|
| UVR 6110 | 56.1 |
| Araldite DY-T | 15 |
| Trimethylolpropane | 2 |
| Sartomer SR399 | 2 |
| Ebecryl 3700 | 18 |
| UVI 6976 | 2.5 |
| 184 | 1 |
| Pyrene | 0.4 |
| Boltorn H2003 | 0 |
| Boltorn H2004 | 3 |
| Total | 100 |

### EXAMPLE 8

The following components were mixed to produce the homogeneous liquid composition of Example 8:

TABLE 9
List of components and percentage by weight for Example 8.

| COMPONENT | PERCENTAGE (by wt.) |
|---|---|
| UVR 6110 | 56.1 |
| Araldite DY-T | 15 |
| Trimethylolpropane | 0 |
| Sartomer SR399 | 5 |
| Ebecryl 3700 | 15 |
| UVI 6976 | 2.5 |
| I-184 | 1 |
| Pyrene | 0.4 |
| Boltorn H2003 | 0 |
| Boltorn H2004 | 5 |
| Total | 100.00 |

The measured mechanical properties for these eight formulations after one hour exposure to UV light or after curing with one hour exposure to UV light and then thermal treatment by heating slowly from room temperature to 140° C. over a two hour period is shown in Table 10.

TABLE 10
List of Eight Example Formulations and Mechanical Properties

| | Measured Property | | | | | | | |
|---|---|---|---|---|---|---|---|---|
| | 1 | 2 | 3 | 4 | 5 | 6 | 7 | 8 |
| Viscosity | 601 | 588 | 566 | 590 | 585 | 578 | 635 | 603 |
| @30 C. | | | | | | | | |

Properties after 1 hr UV Curing:

| | | | | | | | | |
|---|---|---|---|---|---|---|---|---|
| Tensile | 2100 | 2000 | 2000 | 1961 | 1980 | 1550 | 2000 | 1481 |
| modulus | | | | | | | | |
| Tensile | 57 | 31-42 | 40 | 41.7 | 45-51 | 45 | 33-34 | 60 |
| strength | | | | | | | | |
| Elongation | 4.25 | 1.2-2.5 | 2.6-4.75 | 3.88 | 4.5-5.5 | 4.4-5.6 | 2.2-3.75 | 3.6 |
| at break | | | | | | | | |

Properties after 1 hour UV curing plus thermal post cure (2 hours, 140° C.)

| | | | | | | | | |
|---|---|---|---|---|---|---|---|---|
| Tensile | 2800 | 2280 | 2400 | 2000 | 2400 | 2500 | 2360 | 2400 |
| modulus | | | | | | | | |
| Tensile | 47-59 | 47.4 | 69-82 | 55-80.7 | 74-84 | 64-77 | 73 | 60-77 |
| strength | | | | | | | | |
| Elongation | 2.6-5.5 | 4.75 | 3.75-6.0 | 5.9-6.5 | 5.1-5.75 | 3.5-4.6 | 4.75-5 | 2.9-4.4 |
| at break | | | | | | | | |
| Tg (DMA, | 157 | 160 | 157 | 161 | 160 | 160 | 162 | 162 |
| max tan | | | | | | | | |
| delta) | | | | | | | | |

This data shows that these compositions do not change their properties even when subjected to extreme heat treatments. Thus, they can be described as heat resistant.

### EXAMPLES 9 to 11

The trade names of the components used in Examples 9 to 11 are shown in Table 11 as follows:

TABLE 11
List of material identities and chemical compositions.

| TRADE NAMES | CHEMICAL DESIGNATION |
|---|---|
| UVACURE 1550 | 3,4-epoxy cyclohexylmethyl-3′,4′- |
| | epoxy cyclohexanecarboxylate |
| EPILOX A 18-00 | Bisphenol A diglycidyl ether |
| GRILONIT F 713 | Poly tetrahydrofuran diglycidyl ether |
| VORANOL CP 450 | Glycerine propoxylated polyether |
| | triol av. Molecular weight 450 |
| CN 2881 | Dendritic polymer with sixteen |
| | acrylate groups per molecule |
| UVI 6976 | Triarylsulfonium |
| | hexafluoroantimonate |
| I-184 | 1-Hydrocyclohexyl phenyl ketone |
| Benzyl dimethyl amine | Benzyl dimethyl amine |

The formulations indicated in the Examples below were prepared by mixing the components with a stirrer at 60° C. until a homogeneous composition was obtained. The physical data relating to these formulations was obtained as follows: the viscosity of each formulation was determined at 30° C. using a Brookfield viscometer; the measured post-cure mechanical properties of the formulations were determined on three-dimensional specimens produced stereolithographically with the aid of a Nd-Yag-laser; the Flex Modulus, Tensile Modulus (MPa), Tensile Strength (MPa), Elongation at Break (%), were all determined according to the ISO 527 method; the IZOD Impact Resistance (notched, kj/m²) was determined according lo the ISO 179 method; and the softening of the cured resins was determined by TMA (thermal mechanical analysis).

### EXAMPLE 9

The following components were mixed to produce the homogeneous mixture of Example 9:

TABLE 12
List of components and percentage by weight for Example 9.

| COMPONENT | PERCENTAGE (by wt.) |
|---|---|
| UVACURE 1550 | 42.985 |
| EPILOX A 18-00 | 20 |
| GRILONIT F 713 | 0 |
| VORANOL CP 450 | 15 |
| CN 2881 | 15 |
| UVI 6976 | 5 |
| I-184 | 2 |
| Benzyl dimethyl amine | 0.015 |
| Total | 100 |

### EXAMPLE 10

The following components were mixed to produce the homogeneous mixture of Example 10:

TABLE 13
List of components and percentage by weight for Example 10.

| COMPONENT | PERCENTAGE (by wt.) |
|---|---|
| UVACURE 1550 | 42.985 |
| EPILOX A 18-00 | 20 |
| GRILONIT F 713 | 0 |
| VORANOL CP 450 | 10 |
| CN 2881 | 20 |
| UVI 6976 | 5 |
| I-184 | 2 |
| Benzyl dimethyl amine | 0.015 |
| Total | 100 |

### EXAMPLE 11

The following components were mixed to produce the homogeneous mixture of Example 11:

TABLE 14
List of components and percentage by weight for Example 11.

| COMPONENT | PERCENTAGE (by wt.) |
|---|---|
| UVACURE 1550 | 43.485 |
| EPILOX A 18-00 | 20 |
| GRILONIT F 713 | 5 |
| VORANOL CP 450 | 4.5 |
| CN 2881 | 20 |
| UVI 6976 | 5 |
| I-184 | 2 |
| Benzyl dimethyl amine | 0.015 |
| Total | 100 |

The measured mechanical properties for these three formulations after one hour exposure to UV light or after curing with one hour exposure to UV light and then thermal treatment by heating slowly from room temperature to either 50° C. or 100° C. over a two hour period is shown in Table 15.

TABLE 15
List of Eight Example Formulations and Mechanical Properties

| | 9 | 10 | 11 |
|---|---|---|---|
| Measured | | | |
| Property | | | |
| Viscosity @ 30 C. | 293 | 305 | 291 |

Properties after 1 hr UV Curing:

| | | | |
|---|---|---|---|
| Flex Modulus | 2688 | 3304 | nm |
| Tensile Modulus | 3055 | 3467 | 3008 |
| Tensile Strength | 61.5 | 71.1 | 67.4 |
| Elongation at | 7.7 | 4 | 4.7 |
| Break | | | |
| Izod impact | 5.3-5.8 | 4.8 | 3.5 |
| notched | | | |
| Softening point | 52.5-57.5 | 61.5 | 58 |

Properties after 1 hr UV curing plus 2 hrs thermal treatment at
50° C.:

| | | | |
|---|---|---|---|
| Flex Modulus | 2854 | 381 | 2786* |
| Tensile Modulus | 3249 | 3176 | 2701* |
| Tensile Strength | 66.3 | 65.3 | 64.3* |
| Elongation at | 5.4 | 6.2 | 7.38 |
| Break | | | |
| Izod impact | 5 | 5.4 | 3.2* |
| notched | | | |
| Softening Point | 66.5 | 72.5 | 95* |

*These starred values for the Example 11 composition were obtained after one hour of curing plus two hours of thermal treatment at 100° C. (instead of the two hours thermal treatment at 50° C. as in Examples 9 and 10).

The high Izod impact values (even after the thermal treatments) mean they are highly impact resistant.

While the invention has been described above with reference to specific embodiments thereof, it is apparent that many changes, modifications, and variations can be made without departing from the inventive concept disclosed herein. Accordingly, it is intended to embrace all such changes, modifications and variations that fall within the spirit and broad scope of the appended claims. All patent applications, patents and other publications cited herein are incorporated by reference in their entirety.

That which is claimed:

1. A liquid radiation-curable composition useful for the production of three-dimensional solid articles in solid freeform fabrication systems, the composition comprising:
(A) at least one cationically polymerizing alicyclic epoxide having at least two epoxy groups;
(B) at least one poly(meth)acrylate compound;
(C) at least one cationic photoinitiator
(D) at least one free radical photoinitiator; and
(E) at least one dendritic polymer having at least six hydroxyl functional groups.

2. The composition of claim 1 wherein the at least one cationically polymerizing alicyclic epoxide having at least two epoxy groups is 3,4-epoxy cyclohexylmethyl-3′,4′-epoxy cyclohexanecarboxylate.

3. The composition of claim 1 wherein the at least one cationically polymerizing alicyclic epoxide is present in an amount from about 40% to about 70% by weight, based on the total amount of the composition.

4. The composition of claim 1 wherein the at least one poly(meth)acrylate compound is dipentaerythritol monohydroxy-pentaacrylate.

5. The composition of claim 1 wherein the at least one poly(meth)acrylate compound is bisphenol A diglycidyl ether diacrylate.

6. The composition of claim 1 wherein the at least one poly(meth)acrylate compound is present in an amount from about 15% to about 35% by weight, based on the weight of the total composition.

7. The composition of claim 1 wherein the at least one dendritic polymer having at least six hydroxyl functional groups is present in an amount from about 1.5% to about 7% by weight, based on the total amount of the composition.

8. The composition of claim 1 wherein the at least one cationic photoinitiator is triarylsulfonium hexafluoroantimonate.

9. The composition of claim 1 wherein the at least one free radical photoinitiator is 1-hydroxycyclohexyl phenyl ketone.

10. The composition of claim 1 wherein the composition additionally contains one or more reactive diluents.

11. A liquid radiation-curable composition useful for the production of three-dimensional solid articles in solid freeform fabrication systems, the composition comprising:
(A) at least one cationically polymerizing alicyclic epoxide having at least two epoxy groups;
(B) at least one dendritic polymer having at least six (meth)acrylate functional groups.
(C) at least one cationic photoinitiator; and
(D) at least one free radical photoinitiator.

12. The composition of claim 11 wherein the at least one cationically polymerizing alicyclic epoxide having at least two epoxy groups is 3,4-epoxy cyclohexylmethyl-3′,4′-epoxy cyclohexanecarboxylate.

13. The composition of claim 11 wherein the at least one cationically polymerizing alicyclic epoxide is present in an amount from about 40% to about 70% by weight, based on the total amount of the composition.

14. The composition of claim 11 wherein the at least one dendritic polymer having at least six (meth)acrylate functional groups is present in an amount from about 10% to about 25% by weight, based on the total amount of the composition.

15. The composition of claim 11 wherein the at least one cationic photoinitiator is triarylsulfonium hexafluoroantimonate.

16. The composition of claim 15 wherein the at least one cationic photoinitiator is present in an amount from about 1% to about 7% by weight, based on the weight of the total composition.

17. The composition of claim 11 wherein the at least one free radical photoinitiator is 1-hydroxycyclohexyl phenyl ketone.

18. The composition of claim 15 wherein the at least one free radical photoinitiator is present in an amount from about 0.5% to about 5% by weight, based on the weight of the total composition.

19. The composition of claim 11 wherein the composition additionally contains at least one reactive diluent.

20. The composition of claim 11 wherein the composition additionally contains benzyl dimethyl amine.
